(19) United States
(12) Patent Application Publication
(10) Pub. No.: US 2017/0261945 A1
(43) Pub. Date: Sep. 14, 2017

(54) Accessory for a Bracelet Watch

(71) Applicant: Mondaine Watch Ltd., Pfaffikon SZ (CH)

(72) Inventor: André Bernheim, Meilen (CH)

(73) Assignee: Mondaine Watch Ltd.

(21) Appl. No.: 15/454,348

(22) Filed: Mar. 9, 2017

(30) Foreign Application Priority Data
Mar. 10, 2016 (FR) 1651994

(51) Int. Cl. G04R 60/04; A44C 5/20; G04B 47/00

(52) U.S. Cl. CPC G04R 60/04; G04B 47/00; A44C 5/2071

(57) ABSTRACT

The invention relates to an accessory (1) for a bracelet watch, comprising a housing configured to receive a wireless communication device assuming the form of a card or a plate comprising an electronic chip.

### TECHNICAL FIELD OF THE INVENTION

The present invention relates to an accessory for a bracelet watch,

### BACKGROUND OF THE INVENTION

In the horology field, more specifically in the field of bracelet watches, today there is a specific category of so-called “connected” watches. These watches, in addition to providing the usual information regarding the passing of time, provide all types of functionalities, in particular communication and/or contactless payment functions. These functionalities are generally implemented using electronic modules built and configured specifically, which are generally an integral part of the mechanism of the watch, which is generally housed in the case thereof. However, since these communication and/or contactless payment functionalities are completely dependent on the presence of the electronic modules that provide them, and since these watches are generally not adapted for it to be possible to remove these electronic modules temporarily, a user must therefore have his watch at all times if he wishes to benefit from these functionalities. Likewise, a user who owns a connected watch providing communication or contactless payment functionalities through specific electronic modules generally cannot extend these functionalities to other watches in his collection.

### BRIEF DESCRIPTION OF THE INVENTION

The invention aims to offset these drawbacks. In particular, the invention aims to provide an accessory for a bracelet watch able to removably receive specific means for wireless communication and/or contactless payment. Another aim of the invention is to provide an accessory for a bracelet watch able to removably receive specific means for wireless communication and/or contactless payment that can be adapted on any watch and can therefore, with no particular effort, be transferred from one watch to another.

These aims are achieved by an accessory according to claim 1 (repetition of the claims).

### BRIEF DESCRIPTION OF THE FIGURES

Other features and advantages of the invention will emerge from reading the following description, in reference to the appended figures, which illustrate:

FIG. 1, a perspective view of an accessory according to a first embodiment of the invention;

FIG. 2, a perspective view of an accessory according to a second embodiment of the invention; and

FIG. 3, a perspective view of an accessory according to a third embodiment of the invention.

### DETAILED DESCRIPTION OF THE INVENTION

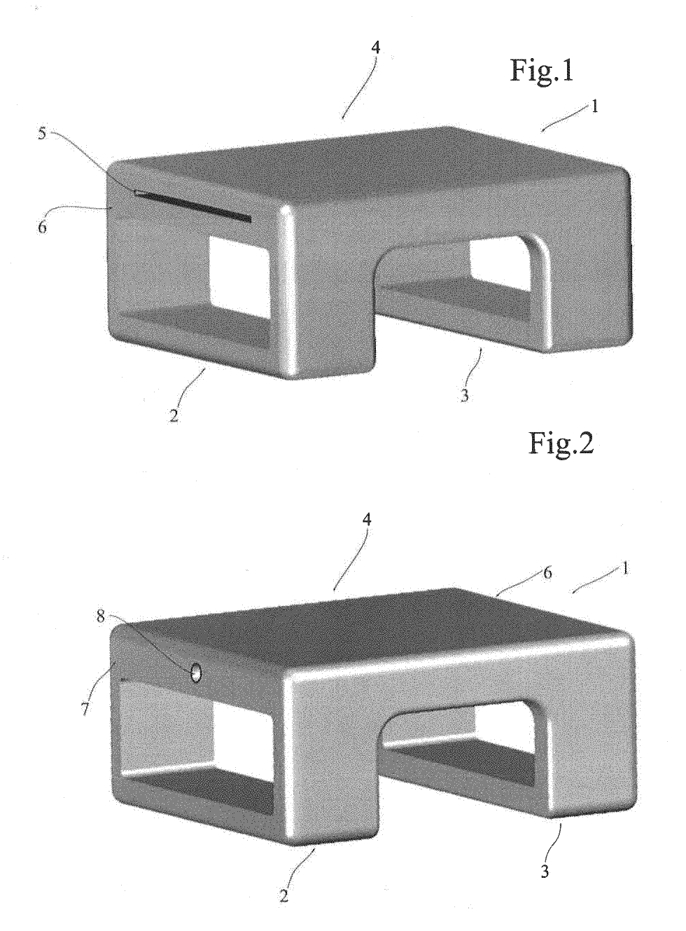

FIG. 1 shows a perspective view of an accessory 1 for a bracelet watch according to a first embodiment of the invention. According to this embodiment, the accessory 1 assumes the form of a loop that comprises two rings 2, 3 that together share an upper part 4 with a substantially parallelepiped shape.

Within the upper part 4 of the accessory 1, a housing is formed that defines a volume suitable for receiving a communication or contactless payment device, which preferably assumes the form of a card, for example a SIM card or any other similar device. Thus, the housing found within the upper part 4 is preferably also parallelepiped.

A first orifice 5 opening the housing to the outside of the accessory 1, advantageously allowing the insertion of a communication or contactless payment device within the housing, preferably defines a rectangular slit on one face 6 of the accessory. Alternatively, the first orifice 5 assumes another shape suitable for receiving a communication or contactless payment device assuming a shape other than a card shape, for example a spherical or cylindrical shape.

When a wireless communication or contactless payment device is in the housing, the user can remove the device from the housing by applying pressure at the face opposite that on which the first orifice 5 is located.

FIG. 2 shows a perspective view of the accessory 1 according to a second embodiment of the invention when a planar rotation of 180° (angle degrees) of the accessory 1 shown in FIG. 1 has been done. In other words, FIG. 2 shows, on the left, the face 7 of the accessory 1 opposite the face 6. According to this second embodiment, on the face 7 is a second orifice 8 communicating with the inside of the housing and configured to allow the insertion of a pointy object, such as a needle, tip, punch or any other small pointy object. The second orifice 8 is used, when a communication or contactless payment device is found in the housing, to push the device outside the housing via the first orifice 5.

Although FIGS. 1 and 2 show an accessory 1 assuming the form of a loop including two rings, the accessory 1 may alternatively assume the form of a loop having only one or more than two rings. One skilled in the art will understand that similarly, a housing provided with one or two orifices may be formed within a loop comprising only one ring or a loop including more than two rings. Furthermore, although the first or second embodiment shows a housing formed in the length of the accessory, the housing may alternatively be formed in the width of the accessory. In the second case, the orifice(s) are of course attached on the other faces of the accessory opposite the housing.

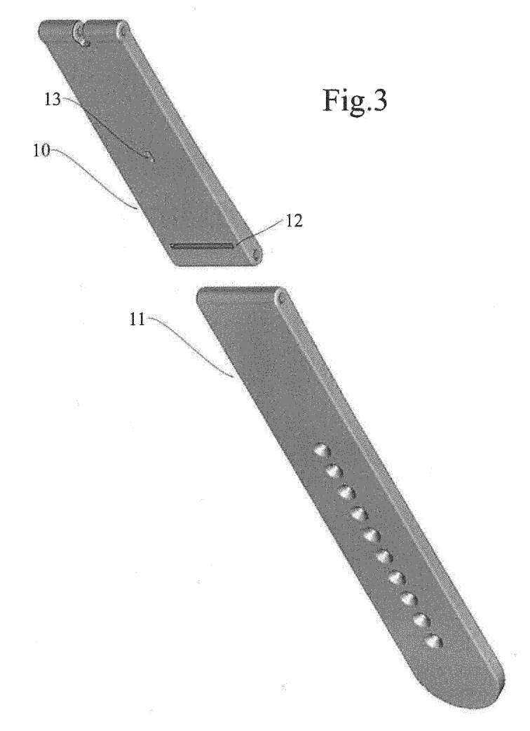

According to a third embodiment of the invention, shown in FIG. 3, the accessory 10 assumes the form of a first watch bracelet strand, which, in the usual manner, comprises a first strand 10 and a second strand 11. As in the first and second embodiments described above, a housing is formed within the first strand 10. The housing is suitable for receiving a communication or contactless payment device, which preferably assumes the form of a card or plate, for example a SIM card or any other device with a similar shape. The housing is provided with a first orifice 12 that defines a rectangular slit through which the communication or contactless payment device can be inserted inside the housing. As before, the shape of the first orifice 12 can alternatively be adapted to another shape assumed by the communication or contactless payment device.

The housing is further provided with a second orifice 13 opening the housing to the outside of the accessory 10 that is configured to allow the insertion of a pointy object and thus facilitate the removal of a communication or contactless payment device located inside the housing. Preferably, the second orifice 13 has an oblong or circular shape. Alternatively, the second orifice has a rectangular, square or triangular shape.

According to a fourth embodiment of the invention, the accessory is similar to that according to the third embodiment, but differs therefrom in that the second orifice 13 is not present.

Although the third or fourth embodiment and FIG. 3 show an accessory that assumes the form of a first bracelet strand, that intended to receive the loop at its end, the accessory can of course equivalently assume the form of a second strand 11. Furthermore, although FIG. 3 shows the orifices on one face of the strand 11, these orifices can of course also be found on the other face of the strand or be formed in the thickness thereof. Lastly, one skilled in the art will understand that although FIG. 3 schematically shows an accessory assuming the form of a bracelet strand that could be made from plastic or leather, the third or fourth embodiment of the invention also encompasses metal bracelet strands.

The accessory according to the invention is preferably made from leather, plastic or a synthetic material. Alternatively, the accessory according to the invention is made from a material containing carbon and/or metal. Preferably, the accessory according to the invention is flexible.

A first advantage imparted by the accessory for a bracelet watch according to the invention is the ability to removably house a communication or contactless payment device within an accessory that may be adapted on any bracelet watch. Indeed, the accessory according to the first or second embodiment can be placed on any watch bracelet—as well as on any jewelry bracelet, a belt, a shoulder strap, a purse strap, etc.—while the accessory according to the third or fourth embodiment can replace any bracelet strand. Thus, by using an accessory according to the invention, a user may transfer the functionalities imparted by a specific communication or contactless payment device from one watch to another in his collection as he wishes.

A second advantage imparted by the accessory according to the invention is that it is adapted so that both the insertion and removal of a communication or contactiess payment device into or out of the accessory can be done without damaging the accessory and without having to modify its structure, even temporarily. The accessory according to the invention therefore allows the user to choose the periods during which he wishes to wear a communication or contactless payment device and without him having to decide not to wear the watch if he does not wish to carry such a device. On this point, the accessory according to the invention therefore allows the user complete freedom of choice.

1. An accessory for a bracelet watch, comprising a housing configured to receive a wireless communication device assuming the form of a card, wherein the housing comprises a first orifice configured to allow the communication device to be inserted into the accessory, such that the wireless communication device can be housed removably in the accessory.

2. The accessory according to claim 1, wherein the housing comprises a second orifice configured so that a pointy object can be inserted therein, such that, when the wireless communication device is housed in the housing, the removal of the communication device from the housing can be done without damaging the accessory and without modifying the structure of the accessory.

3. The accessory according to claim 1, wherein the accessory assumes the form of a loop for a bracelet of a bracelet watch.

4. The accessory according to claim 3, wherein the loop comprises two rings.

5. The accessory according to claim 1, wherein the accessory assumes the form of a strand of a bracelet watch.

6. The accessory according to claim 5, wherein the strand is provided with a loop or part of a clasp.

7. The accessory according to claim 1, wherein the accessory is made from plastic, a synthetic material, a material containing carbon and/or a metal or leather.

8. The accessory according to claim 1, wherein the orifice assumes the form of a rectangular slit.

9. The accessory according to claim 2, wherein the second orifice has a circular or oblong shape.

10. A bracelet watch, wherein the watch is provided with an accessory according to claim 1.

11. The accessory according to claim 2, wherein the accessory assumes the form of a strand of a bracelet watch.
